(19) United States
(12) Patent Application Publication
(10) Pub. No.: US 2010/0300589 A1
(43) Pub. Date: Dec. 2, 2010

(54) Wheel having a segmented tire

(76) Inventor: Robert L. Henry, Marysville, CA (US)

Correspondence Address: Douglas E. Mackenzie, P.O. Box 1295, Mt. View, CA, 94042, US

(21) Appl. No.: 12/455,522

(22) Filed: Jun. 2, 2009

(51) Int. Cl. B60B 5/00; B60C 7/00

(52) U.S. Cl. 152/306

(57) ABSTRACT

A wheel having a segmented tire includes a plurality of tire segments, a hub having a means for radially securing the plurality of tire segments therearound, and a front plate attachable to the hub in abutting relationship to the plurality of tire segments.

### BACKGROUND OF THE INVENTION

The present invention generally relates to wheels and more particularly to a wheel having a segmented tire, the wheel including a plurality of tire segments, a hub having a means for radially securing the plurality of tire segments therearound, and a front plate attachable to the hub in abutting relationship to the plurality of tire segments.

U.S. Pat. No. 4,153,094 discloses a tire section individually securable to a wheel rim with other tire sections to form a tire so that such sections are replaceable when worn or damaged. A substantially flexible tire section having a flat area is secured to a sealing adaptor plate through a steel ring mounting member integral with the tire section. The steel ring may be mounted in the bead of the tire, the bead facing inwardly or outwardly. Either a bolt or a clamp may be employed to secure the tire section to the flat sealing adaptor plate. The adaptor plate in turn may be mounted on a tire rim surface lying in a circumferential plane transversely extending from a wheel. The disclosed tire sections are unnecessarily complex and expensive.

What is needed is a wheel having a segmented tire that is simple, adaptable to a variety of uses, easy to use, and inexpensive to manufacture and use.

### SUMMARY OF THE INVENTION

The wheel having a segmented tire in accordance with an aspect of the invention includes a plurality of tire segments, a hub having a means for radially securing the plurality of tire segments therearound, and a front plate attachable to the hub in abutting relationship to the plurality of tire segments.

In accordance with another aspect of the invention, a wheel having a segmented tire includes a plurality of tire segments, a hub having a means for radially securing the plurality of tire segments therearound and a back plate, and a front plate attachable to the hub in abutting relationship to the plurality of tire segments, the plurality of tire segments being disposed between the back plate and the front plate.

In accordance with yet another aspect of the invention, a wheel having a segmented tire includes a plurality of wedge-shaped tire segments, a cylindrical hub having a means for radially securing the plurality of tire segments therearound and a back plate, the plurality of wedge-shaped tire segments being in abutting relationship to the back plate and to each other, and a front plate attachable to the hub in abutting relationship to the plurality of tire segments, the plurality of tire segments being disposed between the front and back plates.

There has been outlined, rather broadly, the more important features of the invention in order that the detailed description thereof that follows may be better understood, and in order that the present contribution to the art may be better appreciated. There are, of course, additional features of the invention that will be described below and which will form the subject matter of the claims appended herein.

In this respect, before explaining at least one embodiment of the invention in detail, it is to be understood that the invention is not limited in its application to the details of design and to the arrangement of the components set forth in the following description or illustrated in the drawings. The invention is capable of other embodiments and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other methods and systems for carrying out the several purposes of the present invention. It is important, therefore, that the claims be regarded as including such equivalent methods and systems insofar as they do not depart from the spirit and scope of the present invention.

### BRIEF DESCRIPTION OF THE DRAWINGS

The present disclosure may be better understood and its numerous features and advantages made apparent to those skilled in the art by referencing the accompanying drawings wherein:

FIG. 1 is a perspective view of a wheel having a segmented tire in accordance with a first embodiment of the invention;

FIG. 2A is a perspective view of the wheel having the segmented tire in accordance with the first embodiment of the invention with a front plate removed;

FIG. 2B is a perspective view of a wheel having a segmented tire in accordance with a second embodiment of the invention with a front plate removed;

FIG. 3 is a front side elevation view of the wheel having a segmented tire of FIG. 2A;

FIG. 4 is a rear side elevation view of the wheel having a segmented tire of FIG. 2A;

FIG. 5 is a cross sectional view of the wheel having a segmented tire taken along line A-A of FIG. 3;

FIG. 6A is a side elevation view of a hub of the wheel having a segmented tire in accordance with the first embodiment of the invention;

FIG. 6B is a perspective view of the hub of FIG. 6A;

FIG. 7 is a plan view of the front plate in accordance with the first embodiment of the invention;

FIG. 8A is a side elevation view of a tire segment in accordance with the first embodiment of the invention;

FIG. 8B is a perspective view of the tire segment of FIG. 8A;

FIG. 9A is a side elevation view of an alternative tire segment in accordance with the invention;

FIG. 9B is a perspective view of the tire segment of FIG. 9A;

FIG. 10 is a partial side elevation view of an alternative means for slidingly securing a plurality of tire segments to a hub in accordance with the invention;

FIG. 11A is a side elevation view of a tire segment having a means for removing the tire segment in accordance with the invention;

FIG. 11B is a cross sectional view of the tire segment taken along line B-B of FIG. 11A;

FIG. 12 is a cross sectional view of a wheel having a segmented tire in accordance with a third embodiment of the invention; and

FIG. 13 is a side elevation view of the hub of the third embodiment of the invention.

### DETAILED DESCRIPTION OF THE INVENTION

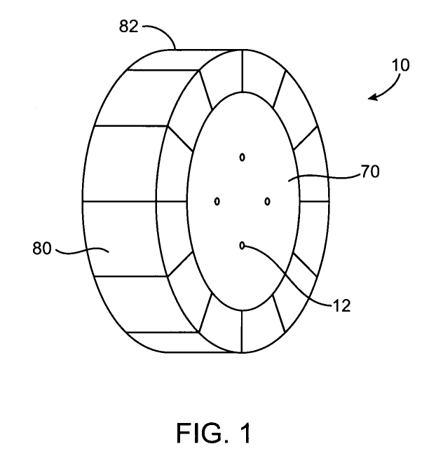

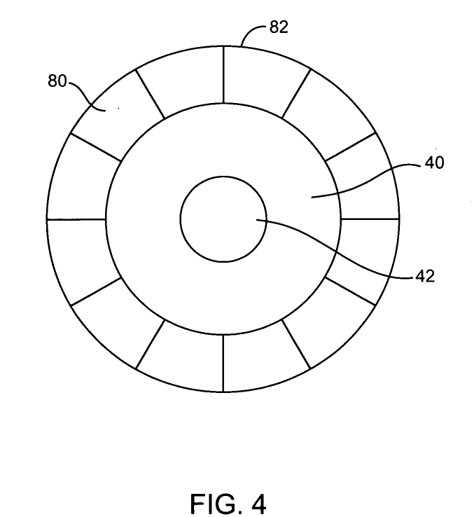

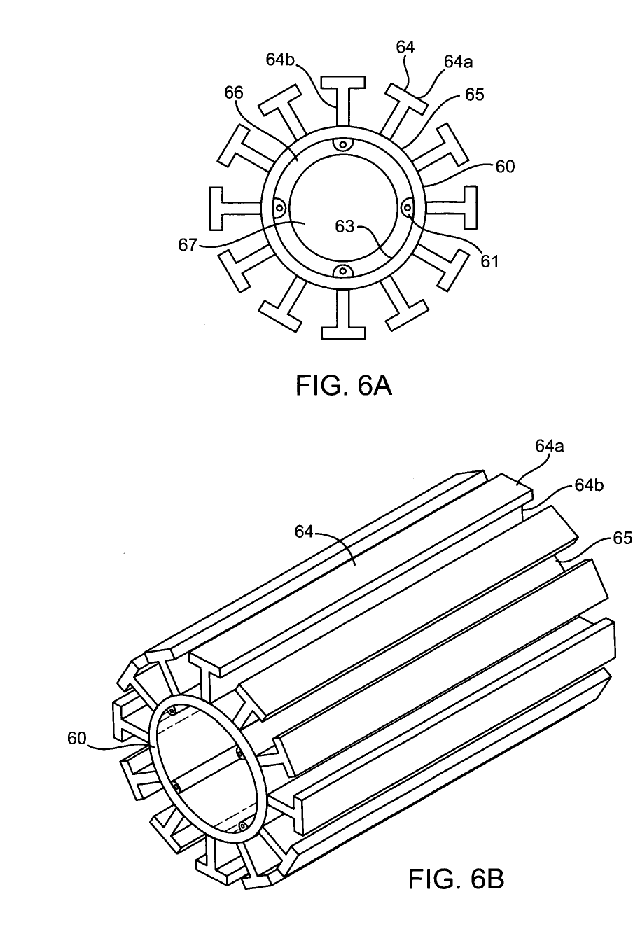

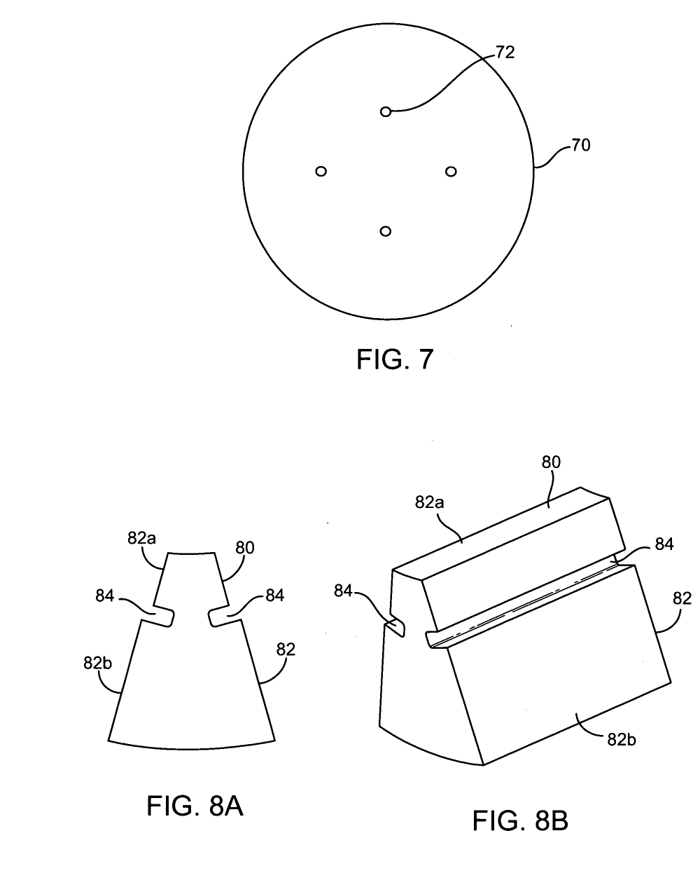

A first embodiment of a wheel having a segmented tire generally designated 10 is shown in FIG. 1. The wheel 10 includes a plurality of generally wedge-shaped tire segments 80 radially secured around a hub 60 (FIGS. 6A and 6B) to form a tire 82. An annular front plate 70 (FIG. 7) is attachable to the hub 60 in abutting relationship to the tire segments 80 and together with a back plate 40 (FIG. 4) laterally secures the tire segments 80 to the hub 60.

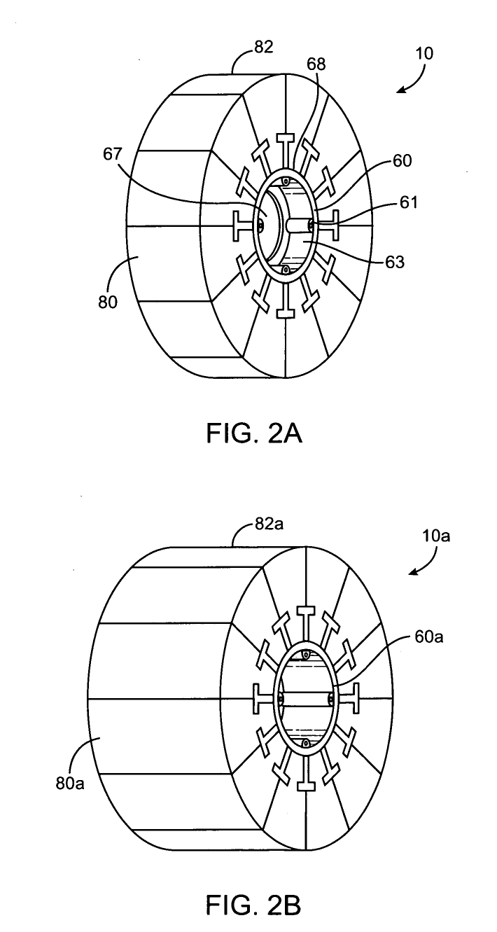

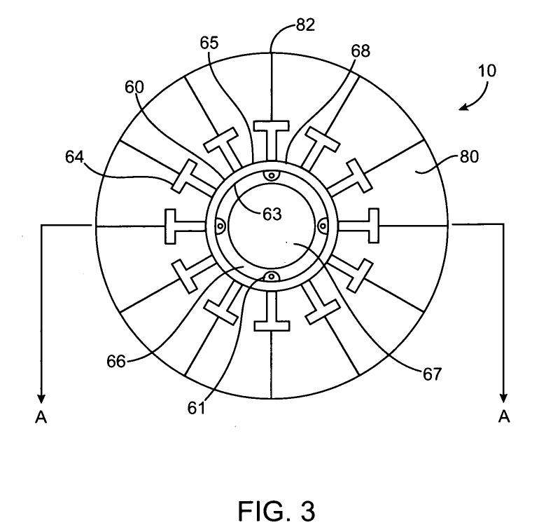

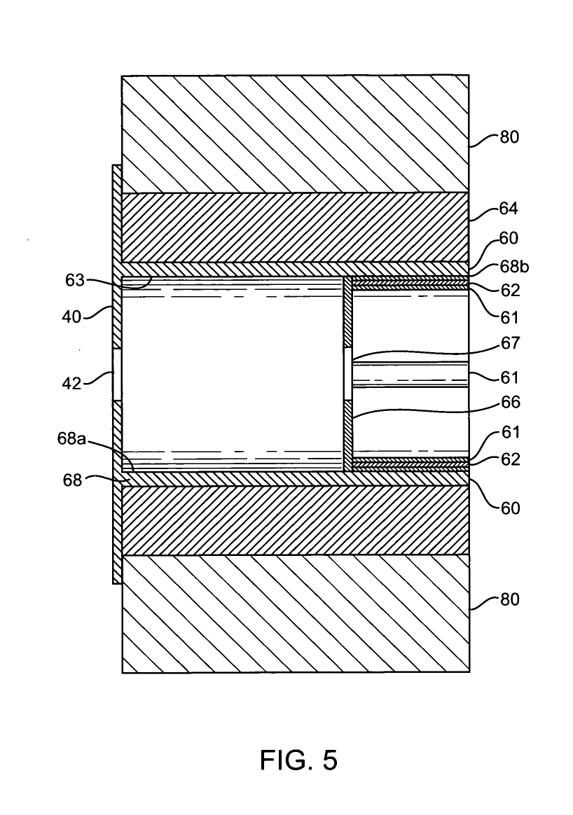

With reference to FIGS. 2A and 3, the wheel 10 is shown with the front plate 70 removed. The hub 60 includes four bolt receiving means 61 spaced about a hub interior surface 63 of a hub body 68 of cylindrical configuration. Each bolt receiving means 61 has a threaded bore 62 (FIG. 5). Holes 72 formed through the front plate 70 are spaced for alignment with the bolt receiving means 61 so that the front plate 70 is concentrically attachable to the hub 60 by means of bolts 12 (FIG. 1).

The hub 60 includes a means for radially securing the plurality of tire segments 80 therearound (FIGS. 6A and 6B). In accordance with the first embodiment of the invention, the means for radially securing the plurality of tire segments 80 includes twelve elements 64 having a T-shaped cross section disposed transversely about an exterior surface 65 of the hub 60 at 30 degree intervals. The elements 64 include an upright portion 64b extending orthogonally from the exterior surface 65 and an upper portion 64a disposed orthogonally from the upright portion 64b in both directions. The elements 64 extend along the length of the hub 60 and adjacent elements 64 radially secure a tire segment 80 therebetween.

Each tire segment 80 (FIGS. 8A and 8B) includes a generally wedge-shaped elongate body 82 having a narrow portion 82a and a wide portion 82b. Channels 84 formed on opposite sides of each tire segment 80 are sized and configured to receive a portion of the upper portion 64a of the elements 64. The channels 84 are preferably formed about one third of the distance from the end of the narrow portion 82a and the end of the wide portion 82b proximate the narrow portion 82a.

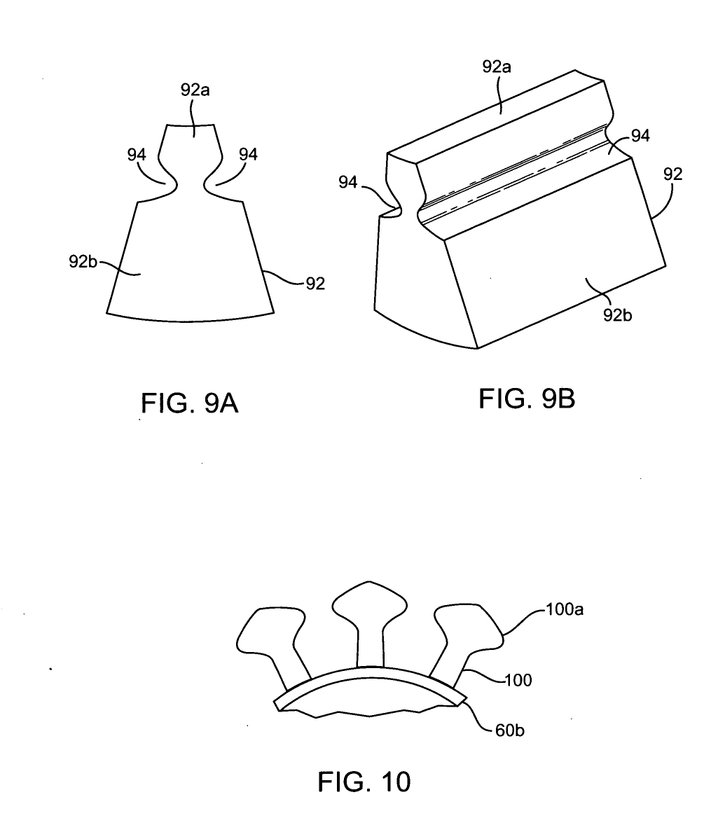

With reference to FIGS. 9A and 9B, there is shown an alternative tire segment 90. Each tire segment 90 includes a generally wedge-shaped elongate body 92 having a narrow portion 92a and a wide portion 92b. Channels 94 formed on opposite sides of each tire segment 90 are sized and configured to receive a portion of an upper portion 100a of an element 100 (FIG. 10) forming part of the means for radially securing the tire segments 90 to a hub 60b. The channels 94 are preferably formed about one third of the distance from the end of the narrow portion 92a and the end of the wide portion 92b of the tire segment 90 proximate the narrow portion 92a.

The hub 60 in accordance with the first embodiment of the invention further includes a back plate 40 disposed at a back portion 68a of the hub body 68 (FIGS. 4 and 5). The back plate 40 includes a circular opening 42 sized to receive an axle (not shown). The back plate 40 is of annular configuration and is sized to extend beyond the extent of the elements 64 of the means for radially securing the plurality of tire segments. The tire segments 80 abut against the back plate 40. Together with the front plate 70, the back plate 40 laterally secures the tire segments 80 to the hub 60.

With continued reference to FIG. 5, the hub 60 further includes an inset plate 66. The inset plate 66 is disposed within the hub body 68 distally of the back plate 40 and proximate a position about ⅔ of the distance from the back portion 68a to a front portion 68b of the hub body 68. The inset plate 66 is inset to accommodate the four bolt receiving means 61 and includes a circular opening 67 (FIG. 2A) sized as the circular opening 42 to receive the axle (not shown) and axially aligned with the circular opening 42 of the back plate 40. The back plate 40 and the inset plate 66 extend interiorly a distance from the interior surface 63 of the hub body 68 to provide space for bearings and other wheel components (not shown).

The tire segments 80 in accordance with the invention may be liquid filled or air filled. The tire segment 80 may be structured. For example, the tire segment 80 may be honeycombed. The tire segments 80 may be solid and have layers of material of different densities. The material composition of the tire segments 80 depends upon the application to which the wheel having the segmented tire 10 is put and the load exerted upon the wheel 10. The tire segments 80 shown in the Figures are exemplary only and one skilled in the art will appreciate that the tire segments 80 may for example have treads, be of different heights relative to adjacent tire segments, and have other materials affixed thereto for added traction. Additionally, the width and height of the wheel having a segmented tire may vary depending upon the application to include a wheel having a segmented tire 10a of greater width than the wheel 10 as shown in FIG. 2B. Wheel 10a includes tire segments 80a forming a tire 82a about a hub 60a.

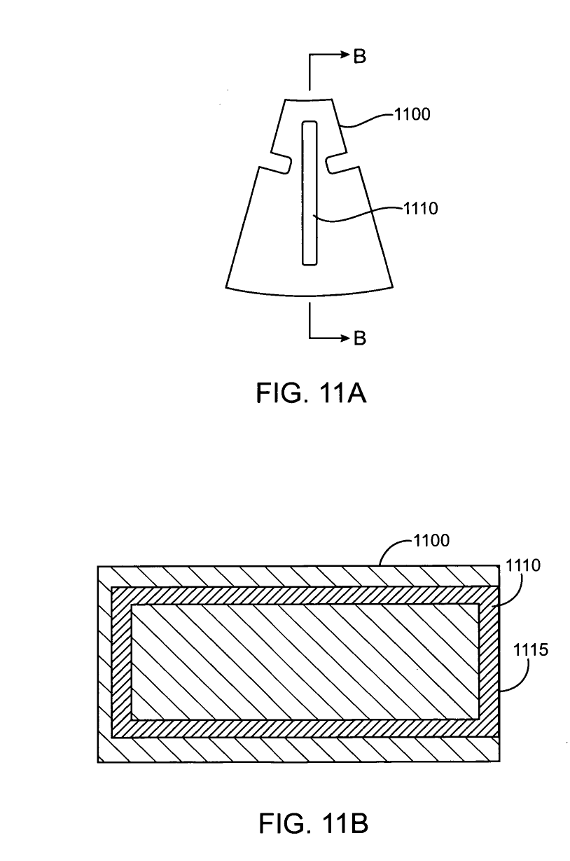

Advantageously, individual tire segments 80 can be easily replaced when worn or damaged. To remove a tire segment 80 from the hub 60, three bolts 12 can be removed, a fourth bolt 12 loosened and the front plate 70 swung about the fourth bolt 12 to expose the tire segment 80 for removal from the hub 60. A worn or damaged tire segment 80 is then simply removed from between the adjacent elements 64, 100 by sliding the tire segment 80 forward. A new tire segment 80 is then slid in place of the worn or damaged tire segment 80 and the front plate 70 reattached to the hub 60. In order to facilitate the removal of a tire segment, a metal frame 1110 may be disposed within a tire segment 1100 as shown in FIGS. 11A and 11B. A tool (not shown) may be used to exert a lateral force upon a section 1115 of the metal frame 1110 to slidingly remove the tire segment 1100.

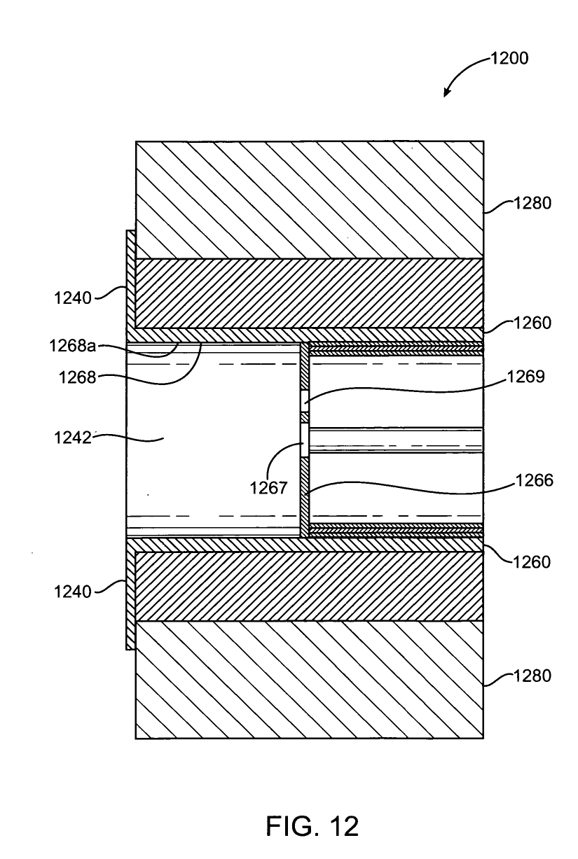

An alternative embodiment of the wheel having a segmented tire 1200 is shown in cross section in FIG. 12. A hub 1260 includes a back plate 1240 disposed at a back portion 1268a of a hub body 1268. The back plate 1240 extends orthogonally from the hub body 1268 and holds tire segments 1280 in abutting relationship thereto. The back plate 1240 includes a circular opening 1242 sized to receive for example a drum at an end of an axle (not shown).

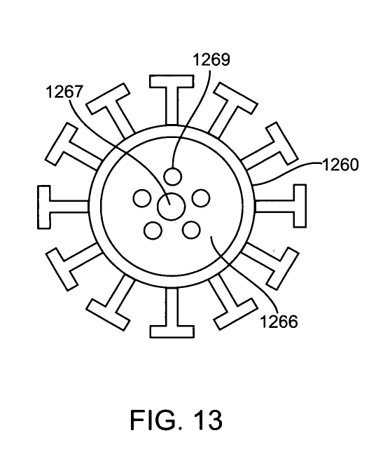

The hub 1260 further includes an inset plate 1266. The inset plate 1266 is disposed midway within the hub body 1268. The inset plate 1266 includes a circular opening 1267 axially aligned with the circular opening 1242 and a lug pattern 1269 as shown in FIG. 13. In use the drum (not shown) may be attached to the inset plate 1266 using lug nuts (not shown).

An exemplary wheel having a segmented tire includes a 10″ wheel for use with a hand truck, lawn mower or wheel barrow. The hub of the 10″ wheel is 4″ in diameter and each tire segment is 3″ in height. The elements of the means for radially securing the tire segments to the hub extend 1 and ¼ inches from the hub body to secure the tire segments to the hub.

One skilled in the art will also appreciate that the wheel having a segmented tire in accordance with the invention may find application in larger vehicles including construction vehicles, earth moving vehicles, and military vehicles. In such applications, the wheel having a segmented tire reduces downtime and thereby reduces the cost of operating such vehicles as worn or damaged tire segments are easily replaced onsite as previously described.

The wheel having a segmented tire in accordance with the invention further reduces costs associated with the operation and construction of vehicles as the tire segments, hub and front plate can be compactly packed and shipped.

The foregoing description of the embodiments of the invention has been presented for the purposes of illustration and description. It is not intended to be exhaustive or to limit the invention to the precise form disclosed. Many modifications and variations are possible in light of the above teaching. For example, the shape of the elements of the means for radially securing the tire segments to the hub may vary to include elements having a cross-shaped cross section. Furthermore, the number of such elements disposed around the hub may be other than described. Additionally, the segmented tire may be enclosed within another tire. It is intended that the scope of the invention be limited not by this detailed description, but rather by the claims appended hereto.

I claim:

1. A wheel having a segmented tire comprising:
a plurality of tire segments;
a hub having a means for radially securing the plurality of tire segments therearound; and
a front plate attachable to the hub in abutting relationship to the plurality of tire segments.

2. The wheel having a segmented tire of claim 1, wherein the plurality of tire segments are wedge-shaped.

3. The wheel having a segmented tire of claim 1, wherein the hub includes a cylindrical body.

4. The wheel having a segmented tire of claim 3, wherein the means for radially securing the plurality of tire segments comprise a plurality of elements having a T-shaped cross section disposed transversely about an exterior surface of the cylindrical body.

5. The wheel having a segmented tire of claim 4, wherein each of the plurality of tire segments include opposed channels each formed to receive a portion of an upper portion of the element having the T-shaped cross section.

5. The wheel having a segmented tire of claim 1, wherein the hub includes a back plate and an inset plate, the back plate and the inset plate having circular openings of identical dimension and wherein the circular openings are axially aligned.

6. The wheel having a segmented tire of claim 5, wherein the plurality of tire segments are disposed between the back plate and the front plate.

7. The wheel having a segmented tire of claim 1, wherein each of the plurality of tire segments has a frame disposed therewithin, the frame including a portion extending outside the tire segment.

8. A wheel having a segmented tire comprising:
a plurality of tire segments;
a hub having a means for radially securing the plurality of tire segments therearound and a back plate; and
a front plate attachable to the hub in abutting relationship to the plurality of tire segments, the plurality of tire segments being disposed between the back plate and the front plate.

9. The wheel having a segmented tire of claim 8, wherein the plurality of tire segments are wedge-shaped.

10. The wheel having a segmented tire of claim 8, wherein the hub includes a cylindrical body.

11. The wheel having a segmented tire of claim 10, wherein the means for radially securing the plurality of tire segments comprise a plurality of elements having a T-shaped cross section disposed transversely about an exterior surface of the cylindrical body.

12. The wheel having a segmented tire of claim 11, wherein each of the plurality of tire segments include opposed channels each formed to receive a portion of an upper portion of the element having the T-shaped cross section.

13. The wheel having a segmented tire of claim 8, wherein the hub includes an inset plate.

14. The wheel having a segmented tire of claim 13, wherein the inset plate has a lug pattern.

15. The wheel having a segmented tire of claim 8, wherein each of the plurality of tire segments has a frame disposed therewithin, the frame including a portion extending outside the tire segment.

16. A wheel having a segmented tire comprising:
a plurality of wedge-shaped tire segments;
a cylindrical hub having a means for radially securing the plurality of tire segments therearound and a back plate, the plurality of wedge-shaped tire segments being in abutting relationship to the back plate and to each other; and
a front plate attachable to the hub in abutting relationship to the plurality of tire segments, the plurality of tire segments being disposed between the front and back plates.

17. The wheel having a segmented tire of claim 16, wherein the means for radially securing the plurality of tire segments comprise a plurality of elements having a T-shaped cross section disposed transversely about an exterior surface of the cylindrical body and wherein each of the plurality of tire segments include opposed channels each formed to receive a portion of an upper portion of the element having the T-shaped cross section.

18. The wheel having a segmented tire of claim 16, wherein the hub includes an inset plate.

19. The wheel having a segmented tire of claim 18, wherein the inset plate includes a lug pattern.

20. The wheel having a segmented tire of claim 18, wherein the inset plate includes a circular opening of identical dimension to a circular opening formed in the back plate and wherein the circular openings are axially aligned.
